(19) United States
(12) Patent Application Publication
(10) Pub. No.: US 2025/0042238 A1
(43) Pub. Date: Feb. 6, 2025

(54) ELECTRIC VEHICLE AND METHODS OF USE THEREOF

(71) Applicant: Polaris Industries Inc., Medina, MN (US)

(72) Inventors: John B. Pircon, Wyoming, MN (US); Austin R. Bartz, Wyoming, MN (US)

(73) Assignee: Polaris Industries Inc., Medina, MN (US)

(21) Appl. No.: 18/837,470

(22) PCT Filed: Feb. 16, 2023
(86) PCT No.: PCT/US2023/062718

§ 371 Date: Aug. 9, 2024

Related U.S. Application Data
(60) Provisional application No. 63/311,248, filed on Feb. 17, 2022.

(51) Int. Cl. B60K 1/04; B60G 7/00; B60G 7/02; B60G 13/00; B60G 21/02; B60G 21/055; B60K 17/22; B60L 50/60

(52) U.S. Cl. CPC B60K 1/04; B60G 7/008; B60G 7/02; B60G 13/001; B60G 21/026; B60G 21/055; B60K 17/22; B60L 50/66; B60G 2200/31; B60G 2200/34; B60K 2001/0422

(57) ABSTRACT

The enclosed disclosure relates to a configuration of an electric vehicle. The embodiments described within provide improvements in the way of packaging associated batteries, motors, transmissions, controllers, and associated components. In the described embodiment enclosed, a vehicle comprises a frame supported by a plurality of ground engaging members, and the frame is configured to support a plurality of seats. The vehicle includes a powertrain comprising a battery supported by the frame and the battery is under at least partially under at least one of the seats. The powertrain also includes a motor supported by the frame and a propeller shaft extends from a position rearward of the battery to a position forward of the battery. The propeller shaft extends along a portion of the vehicle centerline, and when viewed from a side perspective view, the propeller shaft laterally overlaps at least a portion of the battery.

### RELATED APPLICATION

This application is related to U.S. Provisional Application No. 63/311,248, filed Feb. 17, 2022, titled ELECTRIC VEHICLE AND METHODS OF USE THEREOF, the entire disclosure thereof is expressly incorporated by reference herein.

### FIELD OF THE DISCLOSURE

The present disclosure relates to an electric vehicle.

### BACKGROUND OF THE DISCLOSURE

Electric vehicles are known in the art. Packaging an electric vehicle powertrain in an off-road vehicle presents challenges, and the advancements of this will be described herein. Electric motors, transmissions, batteries, and propeller shafts are disclosed herein.

### SUMMARY OF THE DISCLOSURE

In a first embodiment, a vehicle comprises a frame supported by a plurality of ground engaging members, and a plurality of seats supported by the frame. The vehicle comprises a centerline extending longitudinally at a lateral midpoint of the vehicle. The vehicle also comprises a powertrain, the powertrain comprises a battery supported by the frame, and the battery is positioned at least partially under at least one of the plurality of seats. The powertrain also comprising an electric motor supported by the frame, the electric motor positioned rearward of the battery. A propeller shaft extends from a position rearward of the battery to a position forward of the battery, and the propeller shaft also extending along a portion of the vehicle centerline, and when viewed from a side perspective view, the propeller shaft laterally overlaps at least a portion of the battery.

Further, the electric motor comprises a motor output, and the motor output is angled relative to the vehicle centerline. The propeller shaft comprises a first propeller shaft and a second propeller shaft and the first propeller shaft has a diameter less than that of the second propeller shaft. The vehicle further comprises a carrier bearing supporting the first propeller shaft, and the carrier bearing is positioned forward of the battery. Further, the electric motor intersects the vehicle centerline.

In yet another embodiment, a vehicle is disclosed. The vehicle comprises a plurality of ground engaging members supporting a frame, and a plurality of seats supported by the frame. The vehicle comprises a first trailing arm extending generally longitudinally and coupling a first wheel of the plurality of ground engaging members to the frame at a first mounting point. The vehicle further comprising a second trailing arm extending generally longitudinally and coupling a second wheel of the plurality of ground engaging members to the frame at a second mounting point. The vehicle also comprises a powertrain comprising an electric motor positioned rearward of the first mounting point and the second mounting point. The powertrain also comprises a battery positioned forward of the first mounting point and the second mounting point, and the electric motor and the battery are positioned vertically lower than at least a portion of at least one of the plurality of seats. Further, a lateral extent of the battery is outward of a lateral extent of the motor.

The vehicle also comprises a transmission coupled to the electric motor, the transmission positioned forward of the electric motor and vertically lower than at least one of the plurality of seats. The transmission is positioned longitudinally rearward of the first mounting point and the second mounting point. The vehicle further comprises a propeller shaft extending forward from the transmission, and the propeller shaft extends adjacent the battery.

In yet another embodiment, a vehicle is disclosed. The vehicle comprising a frame supported by a plurality of ground engaging members. The vehicle comprises a first trailing arm coupled between the frame and a first ground engaging member of the plurality of ground engaging members, and the first trailing arm is coupled to the frame at a first mounting point and coupled to the first ground engaging member at a second mounting point. The vehicle also comprises a second trailing arm coupled between the frame and a second ground engaging member of the plurality of ground engaging members, and the second trailing arm is coupled to the frame at a third mounting point and coupled to the second ground engaging member at a fourth mounting point. The vehicle includes a first shock absorber extending between the frame at a first shock mounting point and the first trailing arm at a second shock mounting point. A second shock absorber extending between the frame at a third shock mounting point and the second trailing arm at a fourth shock mounting point. A boundary is defined by a plurality of lines drawn through the first mounting point, the second mounting point, the third mounting point, and the fourth mounting point. The vehicle includes a powertrain comprising an electric motor and a transmission operably coupled and supported by the frame, the transmission and electric motor positioned completely within the boundary. The vehicle further comprises a sway bar coupled to the first trailing arm, the second trailing arm and the frame, and the sway bar extends within the boundary.

The vehicle also comprises a battery supported by the frame, and the battery is electrically coupled to the electric motor, and when the vehicle is viewed from a front view the battery is positioned horizontally intermediate the second mounting point and the fourth mounting point. Further, the motor is positioned laterally intermediate, and vertically below, the first shock mounting point and the third shock mounting point. The vehicle further comprises a motor controller, and the motor controller is positioned within the boundary.

### BRIEF DESCRIPTION OF THE DRAWINGS

FIG. 1 is a front perspective view of a representative vehicle of the present disclosure;

FIG. 2 is a rear perspective view of the vehicle of FIG. 1;

FIG. 3 is a front perspective view of a frame of a representative vehicle of the present disclosure;

FIG. 4 is a rear perspective view of a frame of the vehicle of FIG. 3;

FIG. 5 is a perspective view of a portion of the powertrain of the present disclosure;

FIG. 6 is a perspective view of a portion of the powertrain of the present disclosure;

FIG. 7 is a side view of a portion of the vehicle of FIG. 3;

FIG. 8 is a bottom view of a portion of the vehicle of FIG. 3;

FIG. 9 is a top view of a portion of the vehicle of FIG. 3;

FIG. 10 is a side view of a rear of a portion of the vehicle of FIG. 3;

FIG. 11 is a side view of a rear of a portion of the vehicle of FIG. 3;

FIG. 12 is a top view of a rear of a portion of the vehicle of FIG. 3;

FIG. 13 is a cross sectional view of a representative vehicle of the present disclosure taken along line 13-13 of FIG. 3;

FIG. 14A is a perspective view of a portion of a representative powertrain of the present disclosure;

FIG. 14B is a perspective view of a portion of a representative powertrain of the present disclosure;

FIG. 15A is a perspective view of a transmission of a representative vehicle of the present disclosure;

FIG. 15B is a perspective view of a transmission of a representative vehicle of the present disclosure;

FIG. 15C is a cross-sectional view of a transmission of a representative vehicle of the present disclosure taken along line 15C-15C of FIG. 15A;

FIG. 16A is an exploded view of the transmission of FIG. 15A;

FIG. 16B is a perspective view of a chain tensioning assembly of a transmission of FIG. 15A;

FIG. 16C is an exploded view of the chain tensioning assembly of FIG. 16B;

and

FIG. 17 is a control diagram of a drive logic of the vehicle of the present disclosure.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

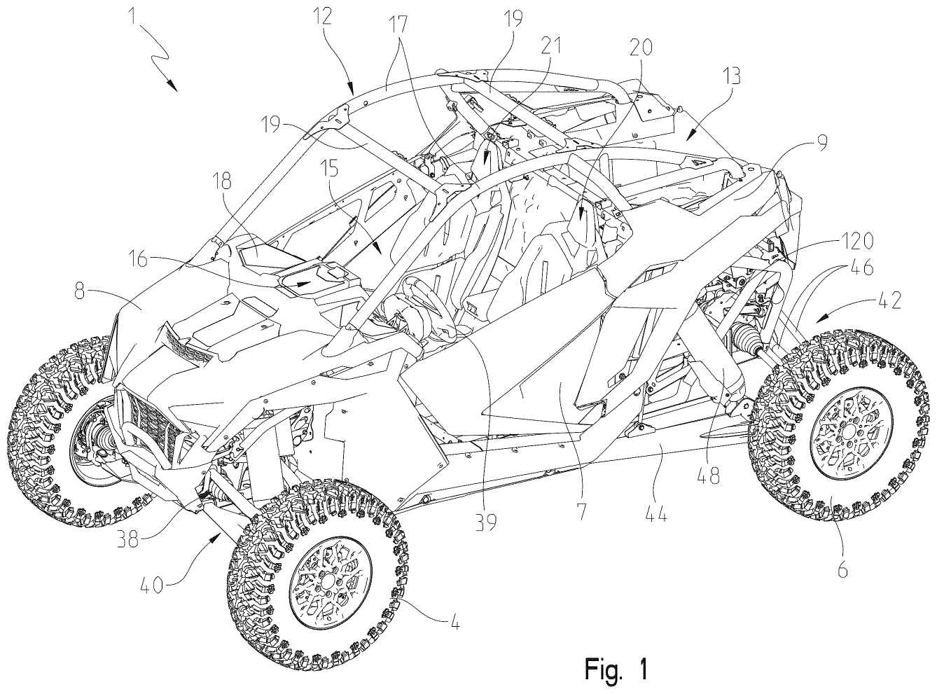

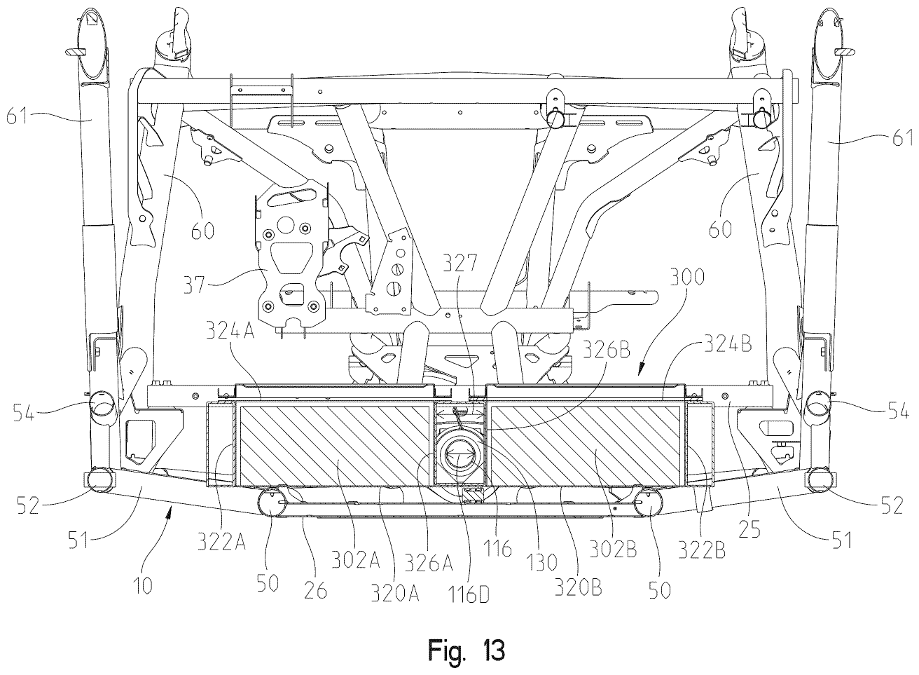

As shown in FIGS. 1-4, a vehicle 1 and a vehicle 2 are shown, and it may be appreciated that vehicles 1 and 2 are slight variations in size, however, they comprise substantially similar systems, components, and frame members, and should be treated as substantially similar. Vehicles 1, 2, include a lower frame assembly 10 supported by a pair of front ground engaging members 4, and a pair of rear ground engaging members 6. Ground engaging members 4, 6 each may be a wheel, a track, a ski, or other type of ground engaging member. An upper frame assembly 12 is supported by lower frame assembly 10. A plurality of doors 7 are configured to allow ingress and egress into and out of an operator area 15. A front suspension 40 is coupled between front ground engaging members 4 and lower frame assembly 10. Front suspension 40 is generally a dual A-arm suspension with a pair of vertically spaced control arms and a biasing member (e.g. shock absorber) extending between the lower frame assembly 10 and one of the control arms. Front suspension 40 may also be a strut-style suspension, or another type of front suspension. Vehicle 2 further includes a steering assembly 38 which provides steering input to front ground engaging members 4. Steering assembly includes a steering wheel 39 coupled to a steering rack (not shown), and in various embodiments, steering wheel 39 may couple to an electronic power steering system (not shown). Steering wheel 39 provides a rotational input to the electronic power steering system and a rotational output is provided from the electronic power steering system to the steering rack. Electronic power steering system may be supported on a power steering frame support 37 (FIG. 13) positioned forward of operator area 15 and vertically below upper frame assembly 12.

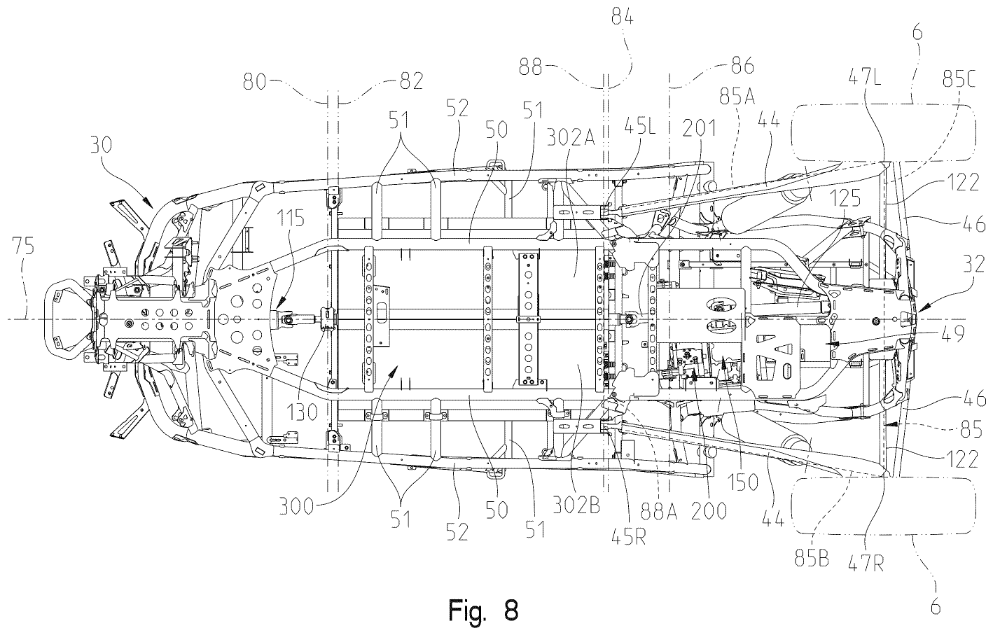

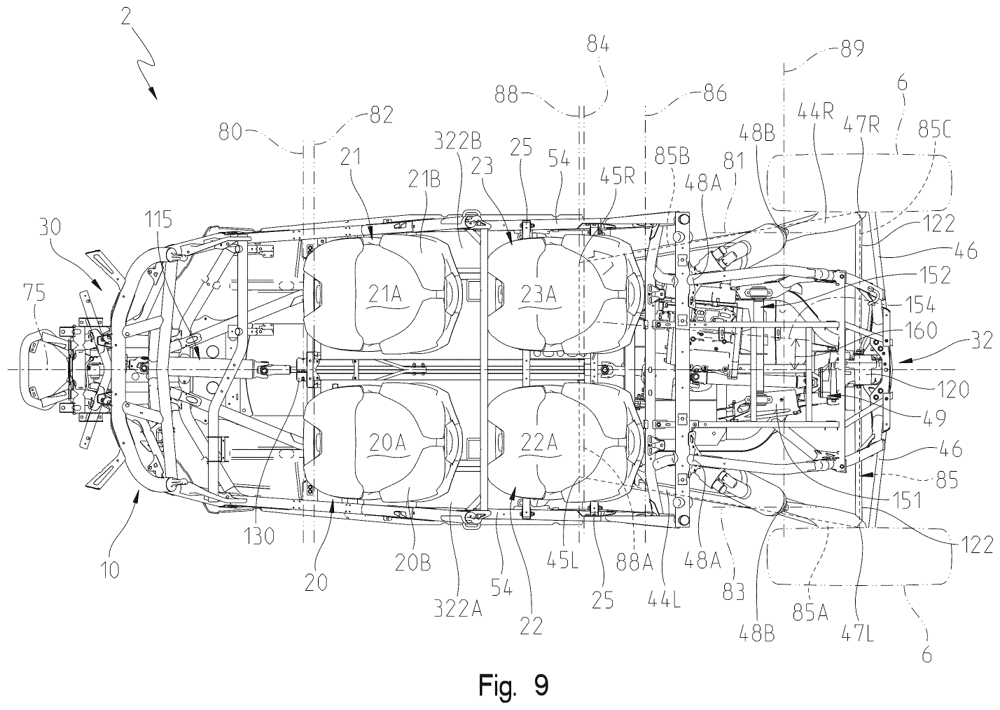

Further, vehicle 2 includes a rear suspension 42 coupled between rear ground engaging members 6 and lower frame assembly 10. Rear suspension 42 includes a pair of trailing arms 44, a plurality of control arms 46 and a pair of shock absorbers 48. Illustratively, trailing arms 44 are operably coupled to rear ground engaging members 6 at a rear trailing arm mounting point 47 (FIG. 8). Trailing arms 44 each extend generally forwardly from rear ground engaging members 6 and couple to lower frame assembly 10 at a forward trailing arm mounting point 45 (FIG. 8). Control arms 46 extend generally laterally between lower frame assembly 10 and ground engaging members 6. Control arms 46 couple to lower frame assembly 10 at a position generally adjacent a rear drive 120. In the present embodiment, control arms 46 operably couple to lower frame assembly 10 at a position rearward of rear drive 120. Shock absorbers 48 extend between lower frame assembly 10 and trailing arms 44. Illustratively, shock absorbers 48 operably couple to lower frame assembly 10 at first shock mounting points 48A and shock absorbers 48 operably couple to trailing arms 44 at second shock mounting points 48B (FIG. 9).

Vehicle 2 also includes a driver seat 20 and a passenger seat 21 located within operator area 15. In various embodiments, vehicle 2 includes a driver seat 20 and no passenger seat 21. In various embodiments, vehicle 2 includes a pair of seats 22, 23 located rearward of front seats 20, 21 (FIG. 9). Seats 20, 21, 22, 23 are coupled to the lower frame assembly through a plurality of seating frames 25. Additionally, each of seats 20, 21, 22, 23 comprises a seat bottom 20A, 21A, 22A, 23A and a seat back 20B, 21B, 22B, 23B, respectively, however, in various embodiments, any of seats 20, 21, 22, 23 may be configured as bench seats (FIG. 9). Vehicle 2 also includes a dash assembly 16 positioned at the front of operator area 15. Dash assembly 16 may support a display (not shown), a user interface, various vehicle inputs, light controls, a handlebar, a storage area 18, or various other components. Vehicle 2 includes a front body panel, or a hood 8, positioned forward of the operator area 15 and generally above front suspension 40 and steering assembly 38. Additionally, vehicle 2 includes a plurality of rear body panels 9 positioned generally rearwardly of doors 7 and operator area 15. Vehicle 2 may further include a rear fascia 11 positioned at a rear extent of vehicle 2, and a tub, or storage area 13, is positioned adjacent the rear of vehicle 2 and configured to provide a space to stow cargo, a tire, a cooler, or other items. Storage area 13 may be a tub, a removable tub, a covered trunk, or other storage area.

Additional details regarding vehicle 2 may be found in U.S. application Ser. No. 16/861,859, filed Apr. 29, 2020, titled VEHICLE, attorney docket no. PLR-15-28561.02P-US; U.S. Pat. No. 10,960,941, issued Mar. 30, 2021, titled VEHICLE, attorney docket no. PLR-15-28382.02P-US; and U.S. application Ser. No. 16/242,626, filed Jan. 8, 2019, titled VEHICLE SEATING ARRANGEMENTS, attorney docket no. PLR-15-28340.06P-US, the complete disclosures of which are expressly incorporated by reference herein.

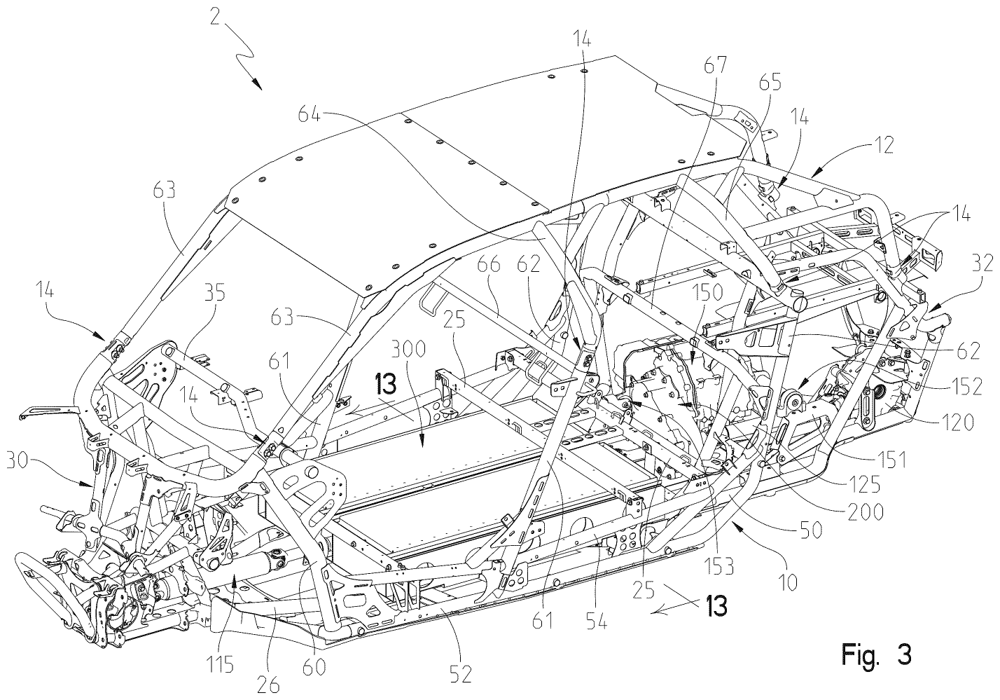

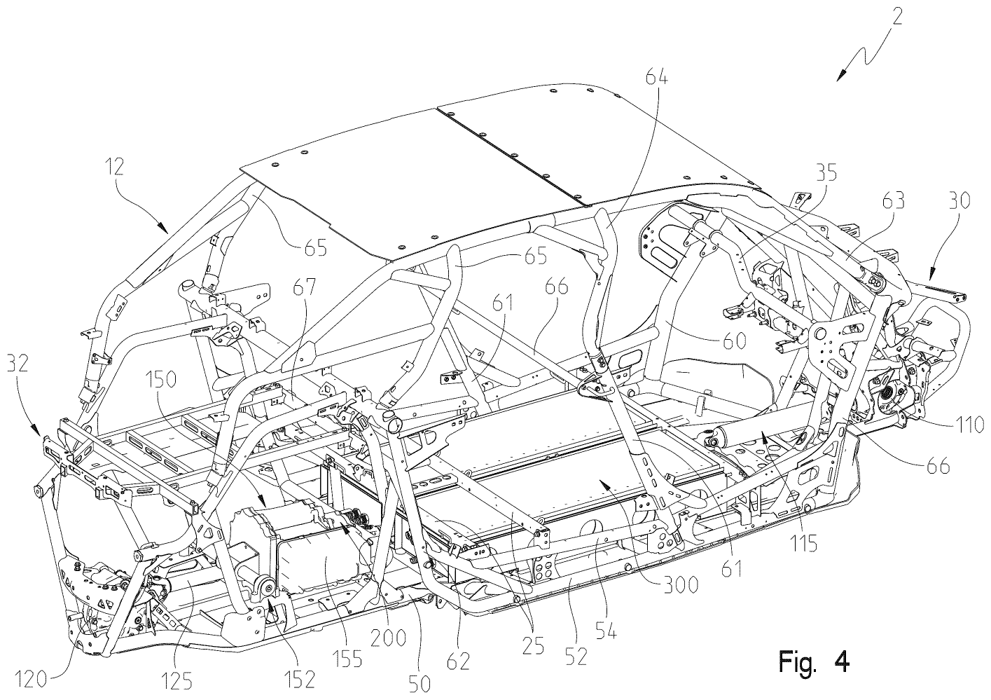

Now referring to FIGS. 3-4, lower frame assembly 10 generally includes a front subframe 30 located forward of operator area 15 and a rear subframe 32 located rearward of operator area 15. Lower frame assembly 10 includes a pair of first vertical members 60, a pair of second vertical members 61, and a third pair of vertical members 62. Illustratively, each of first vertical members 60, second vertical members 61, and vertical members 62 are positioned longitudinally intermediate the front subframe 30 and rear subframe 32; however, in other embodiments, any of first, second, and/or third vertical members 60, 61, 62 may comprise a portion of front and/or rear subframe 32.

Lower frame assembly 10 includes first lower frame members 50, second lower frame members 52 and third lower frame members 54. Illustratively, first lower frame members 50 extend longitudinally at a position laterally inward from an outer extent of lower frame assembly 10. Further, second lower frame members 52 extend generally longitudinally and are positioned at a lower extent of a lateral outer extent of lower frame assembly 10. Additionally, second lower frame members 52 are positioned laterally outward from first lower frame members 50. Further, third lower frame members 54 are positioned generally vertically above second lower frame members 52 and extend generally longitudinally along a portion of a lateral outer extent of vehicle 2. Lower frame assembly 10 includes a plurality of lateral support members 51 extending between first lower frame members 50 and second lower frame members 52.

Upper frame assembly 12 includes a pair of fourth vertical members 63, a pair of fifth vertical members 64, and a pair of sixth vertical members 65. Illustratively, upper frame assembly 12 couples to lower frame assembly 10 using a plurality of couplers 14. A coupler 14 is positioned between first vertical members 60 and fourth vertical members 63, a coupler 14 is positioned between second vertical members 61 and fifth vertical members 64, and a coupler 14 is positioned between third vertical members 62 and sixth vertical members 65. In various embodiments, a first coupler is positioned at the top of each of first vertical members 60, second vertical members 61, and vertical members 62, and a second coupler configured to mate with the first coupler is positioned at the bottom of each of fourth vertical members 63, fifth vertical members 64, sixth vertical members 65, respectively. Upper frame assembly 12 generally comprises a pair of longitudinally extending frame members 17 extending over operator area 15 and coupled together by a pair of laterally extending frame members 19. Longitudinally extending frame members 17 and laterally extending frame members 19 cooperate with vertical frame members 63, 64, 65 to surround operator area.

Vehicle 2 may further include a first support member 35 configured to support dash assembly 16. Additionally, an intermediate support member 66 extends between each of second vertical members 61 and may be a brace for passengers in seats 22 and seats 23. Vehicle 2 may additionally include support member 67 extending between each of vertical members 62. Support member 67 is positioned rearwardly of seats 22 and seats 23 and is positioned adjacent a rear extent of operator area 15.

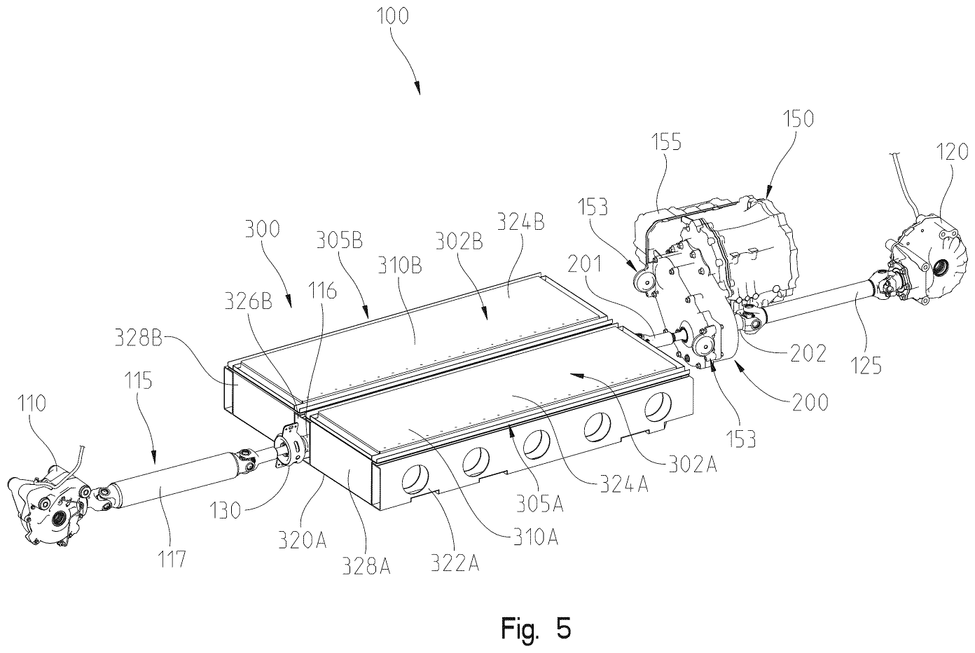

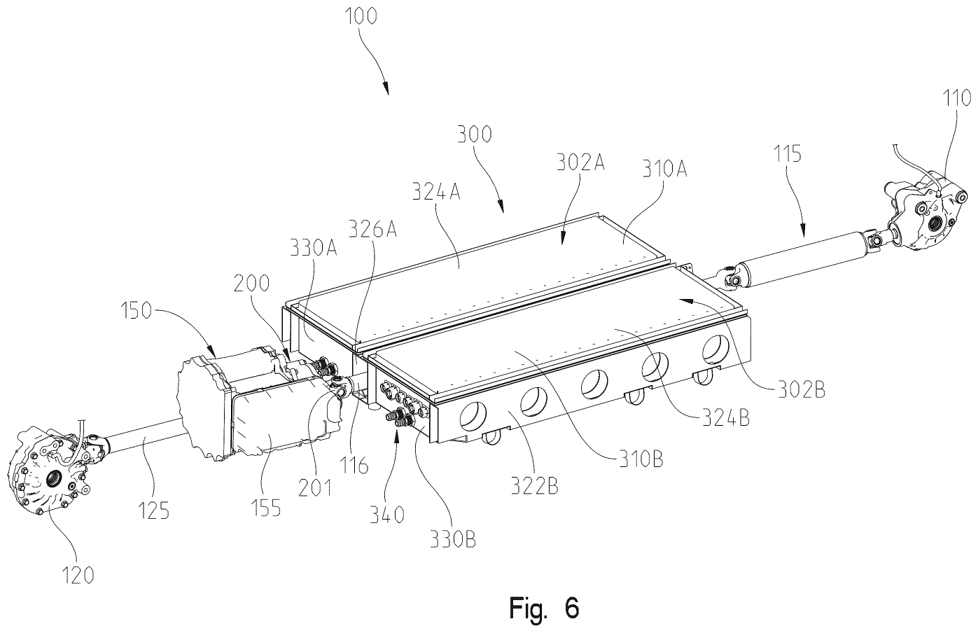

Referring to FIGS. 5-6, vehicle 2 includes a powertrain assembly 100 positioned generally along a bottom of lower frame assembly 10. Illustratively, powertrain assembly 100 comprises an electric motor 150. In one embodiment, electric motor 150 may be coupled to at least one gear, such as a gearbox, differential, or the like, and illustratively is operably coupled to a chain case, or transmission 200. Chain case 200 includes a forward output 201 and a rearward output 202. A rear propeller shaft assembly 125 extends rearwardly from rearward output 202 to the rear drive 120 which is positioned generally within, and at a rearward extent of, rear subframe 32. A pair of half shafts 122 (FIG. 8) extend and transmit rotational power between rear drive 120 and rear ground engaging members 6. Further, a front propeller shaft assembly 115 extends forwardly from chain case 200 to a front drive 110 positioned generally within front subframe 30. A pair of half shafts (not shown) extend between front drive 110 and front ground engaging members 4. Powertrain assembly 100 also includes a power source 300. In the present embodiment, power source 300 includes batteries 302, including a first battery 302A and a second battery 302B. Power source 300 may be a single battery 302 or may further include additional batteries 302. Batteries 302 are positioned along a bottom of lower frame assembly 10 and are laterally spaced such that front propeller shaft assembly 115 extends laterally between batteries 302. In various embodiments, propeller shaft 115 extends adjacent battery 302.

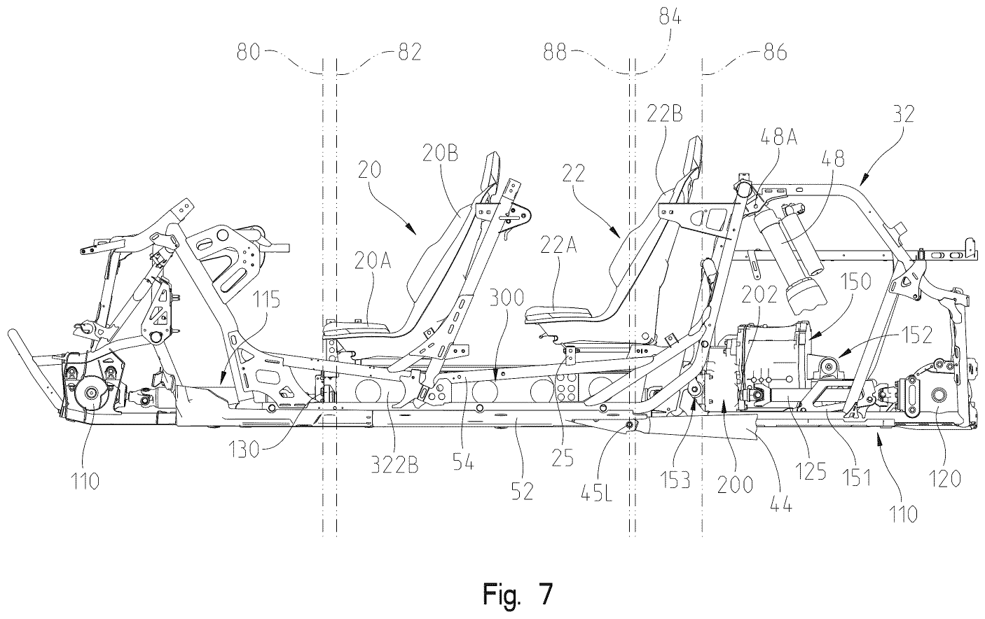

In the present embodiment, motor 150 is coupled to lower frame assembly 10 through motor mount 152 (FIG. 7). Motor mount 152 may comprise an isolator or a plurality of isolators which couple to frame mounting members 151 to reduce the vibration transmitted through motor mount 152. Illustratively, motor mount 152 is positioned along a rear face of motor 150. Powertrain assembly 100 further includes a pair of forward motor mounts 153 positioned along a front side of the chain case 200. Forward motor mounts 153 may also include an isolator or a plurality of isolators to reduce the vibration transmitted through motor mounts 153. Motor 150 and chain case 200 are mounted to lower frame assembly 10 through motor mounts 152 and 153. Powertrain assembly 100 also includes a motor controller 155 operably coupled to motor 150. In various embodiments, motor controller 155 is positioned separately from motor 150, although in other embodiments, motor 150 may include motor controller 155 therewith. In the present embodiment, motor 150, motor controller 155, and chain case 200 are positioned generally within rear subframe 32.

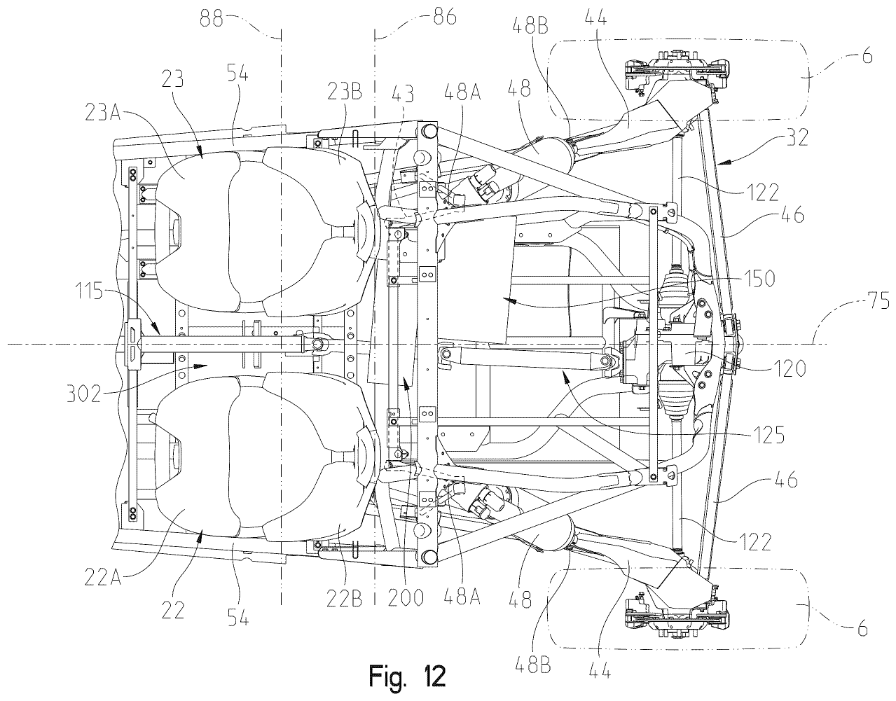

Referring to FIGS. 3-12, powertrain assembly 100 will be explained in greater detail. In the present embodiment, motor 150 is a DC brushless motor. In various embodiments, motor 150 may be an AC induction motor, a permanent magnet DC motor, or other type of motor. Motor 150 is positioned such that the output (not shown) is in a generally north/south direction such that the output of motor 150 extends generally longitudinally, and the output of motor 150 is facing generally forward. In the present embodiment, the output of motor 150 is positioned along line 154 which is angled at an angle 160 relative to a longitudinally extending centerline 75 of vehicle 1, 2. In various embodiments, angle 160 is between 0 degrees-20 degrees; in yet other embodiments, angle 160 is between 0 degrees and 45 degrees. In various embodiments, angle 160 is 0 degrees and the output is positioned along line 154 that is parallel to or colinear with centerline 75. The output of motor 150 is configured to rotate about line 154 and provide rotational power to chain case 200 and/or other components of powertrain assembly 100.

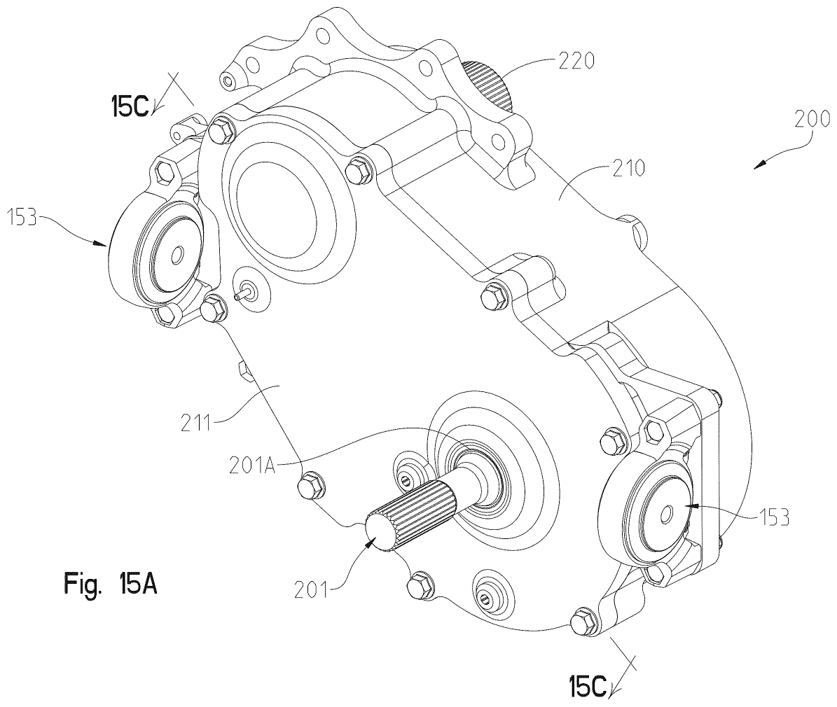

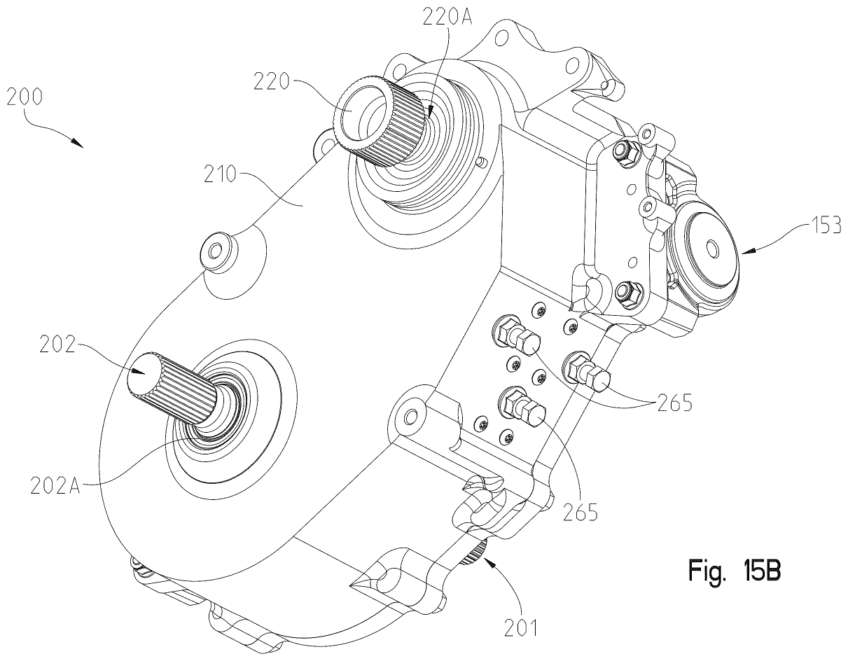

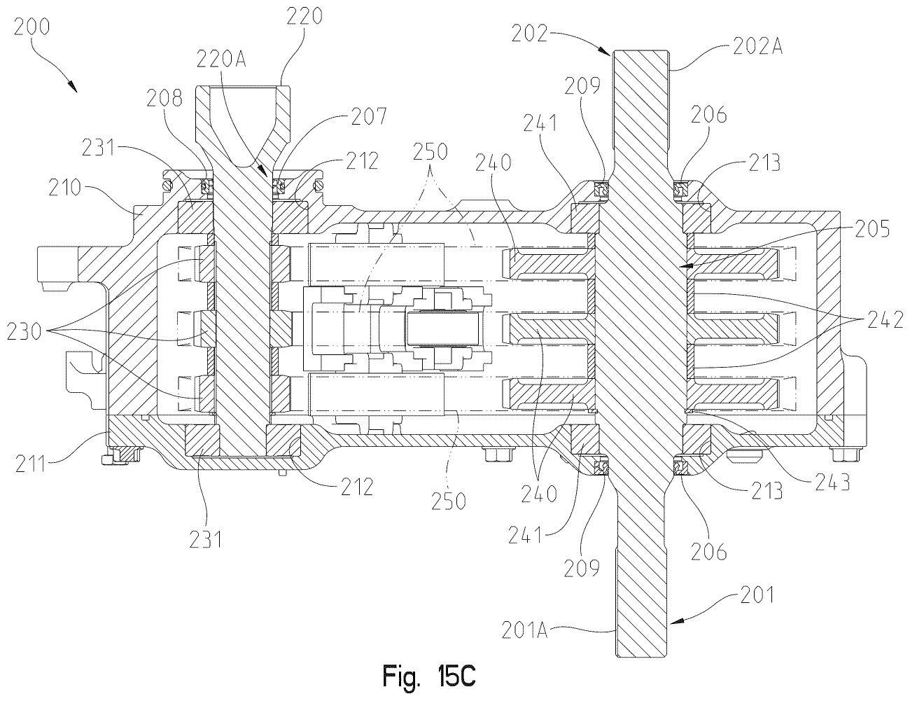

The motor output is coupled to chain case 200 at a chain case input 220 (FIG. 15A). Chain case 200 transmits rotational power from motor 150 to front propeller shaft assembly 115 and rear propeller shaft assembly 125. Illustratively, chain case 200 provides rotational power to front propeller shaft assembly 115 and rear propeller shaft assembly 125 at forward output 201 and rearward output 202, respectively. Forward output 201 and rearward output 202 are parallel to the output of motor 150 and, therefore, forward output 201 and rearward output 202 are angled at an angle 160 from centerline 75.

Front propeller shaft assembly 115 comprises a first propeller shaft 116 and a second propeller shaft 117. In the present embodiment, first propeller shaft 116 is coupled to forward output 201 using a CV joint, and first propeller shaft 116 is positioned generally along centerline 75. In various embodiments, first propeller shaft 116 is offset but parallel to centerline 75. Illustratively, first propeller shaft 116 is coupled to forward output 201 at a position longitudinally rearward of batteries 302. First propeller shaft 116 extends forwardly along the entire length of batteries 302 and couples to second propeller shaft 117 using a CV joint at a position forward of batteries 302. Illustratively, first propeller shaft 116 is supported by a carrier bearing 130 at position adjacent the front of batteries 302. Second propeller shaft 117 extends forwardly and couples to front drive 110 and provides rotational power to front ground engaging members 4. In various embodiments first propeller shaft has a diameter 116D that is smaller than a diameter (not shown) of second propeller shaft 117. Illustratively, from a side perspective, the propeller shaft assembly 115 laterally overlaps at least a portion of the battery 302.

Batteries 302 include cells 310A, 310B positioned inside a frame 305 comprised of a first frame 305A and a second frame 305B. Illustratively, first frame 305A comprises a bottom wall 320A, an outer wall 322A, an upper wall 324A, an inner wall 326A, a forward wall 328A, and a rear wall 330A. Further, second frame 305B comprises a bottom wall 320B, an outer wall 322B, an upper wall 324B, an inner wall 326B, a forward wall 328B, and a rear wall 330B. Front walls 328A, 328B are coupled together to provide rigidity at a front of frame 305. Additionally, rear walls 330A, 330B are coupled together to provide rigidity at a rear of frame 305. In various embodiments, the front walls 328A, 328B support the carrier bearing 130. In further embodiments, carrier bearing 130 is supported by the lower frame assembly 10. Outer walls 322A, 322B are a metal extrusion generally shaped with a rectangular cross-section to increase rigidity of frame 305 and prevent batteries 302 from moving laterally within frame 305. In various embodiments, inner walls 326A, 326B are coupled together. In various embodiments, inner walls 326A, 326B are a part of a metal extrusion generally shaped with a rectangular cross-section. In various embodiments, upper walls 324A and 324B are a single piece and extends over batteries 302A, 302B, and front propeller shaft assembly 115.

Vehicle 2 also includes a skid plate 26 positioned at a lowest extent of lower frame assembly 10. As best seen in FIG. 13, skid plate 26 extends between first lower frame members 50. The lowest extent of batteries 302 is positioned above a lowest extent of second lower frame members 52. Additionally, an upper extent of batteries 302 is positioned below an upper extent of third lower frame members 54. Further, battery 302 extends over first lower frame members 50 and skid plate 26. In various embodiments, upper wall 324A and upper wall 324B support seating frame 325. Seating frame 325 may be coupled to upper wall 324A and upper wall 324B.

As best seen in FIGS. 7-9, a forward extent 82 of batteries 302 is positioned behind a lateral plane 80 defined by the front of seats 20, 21. Additionally, a rear extent 84 of batteries 302 is positioned in front of a lateral plane 86 defined by the rear extent of seats 22, 23. Therefore, batteries 302 are positioned such that the foot position of a driver or passenger in seats 20, 21 is not affected by batteries 302, and further, batteries 302 do not extend into the rear subframe 32. In various embodiments, lateral plane 80 extends vertically through carrier bearing 130. In various embodiments, seat bottoms 22A, 23A are positioned vertically above seat bottoms 20A, 21A. Additionally, a lateral extent of batteries 302 is positioned laterally outward of a lateral extent of motor 150.

In the present embodiment, motor 150, chain case 200, and motor controller 155 are positioned rearward of a lateral plane 88 extending between forward trailing arm mounting points 45. Further, a rear subframe area 49 is defined by a boundary 85 consisting of the following: a line 88A extending along plane 88, a line 85A extending between a left forward trailing arm mounting point 45L and left rear trailing arm mounting point 47L, a line 85B extending between a right forward trailing arm mounting point 45R and right rear trailing arm mounting point 47R, and a line 85C extending between left rear trailing arm mounting point 47L and right rear trailing arm mounting point 47R. Rear subframe area 49 is defined using the position of trailing arms 44 when vehicle 2 is at rest. In various embodiments, an entirety of motor 150 is positioned within rear subframe area 49. In various embodiments, an entirety of motor 150 and chain case 200 are positioned within rear subframe area 49. In various embodiments, an entirety of motor 150, chain case 200, and motor controller 155 are positioned within rear subframe area 49. In the present embodiment, front propeller shaft assembly 115 extends across the boundary created by rear subframe area 49. In various embodiments, second propeller shaft assembly 125 is entirely positioned within rear subframe area 49.

In various embodiments, motor 150 is positioned substantially to one side of centerline 75. In various embodiments, a portion of motor 150 may cross or intersect vehicle centerline 75 such that one portion of motor 150 is to the right of centerline 75 while the remainder of motor 150 to the left of centerline 75. Further, motor 150 is positioned forward of a vertical plane 89 extending through second shock mounting points 48B. Further, motor 150 extends across a vertical plan 87 extending through first shock mounting points 48A. In various embodiments, each of batteries 302, front propeller shaft assembly 115, chain case 200, electric motor 150, motor controller 155 are positioned laterally between a vertical plane 81 extending longitudinally forward from second shock mounting points 48B on right trailing arm 44R and a vertical plane 83 extending longitudinally forward from second shock mounting points 48B on left trailing arm 44L.

In the present embodiment, motor 150, chain case 200, and motor controller 155 are positioned laterally inward of an outer extent of each of outer wall 322A, outer wall 322B. Further, an upper extent of motor 150, chain case 200, and/or motor controller 155 is positioned vertically below an upper extent of seat bottoms 22A, 23A. In other words, the upper extent of motor 150, chain case 200, and/or motor controller 155 is at a vertical height greater than that of the upper extent of seat bottoms 22A, 23A. In various embodiments, an upper extent of motor 150, chain case 200, and motor controller 155 is positioned vertically below an upper extent of seat bottoms 20A, 21A, 22A, 23A. In other words, the upper extent of motor 150, chain case 200, and/or motor controller 155 is at a vertical height less than that of the upper extent of seat bottoms 20A, 21A, 22A, 23A.

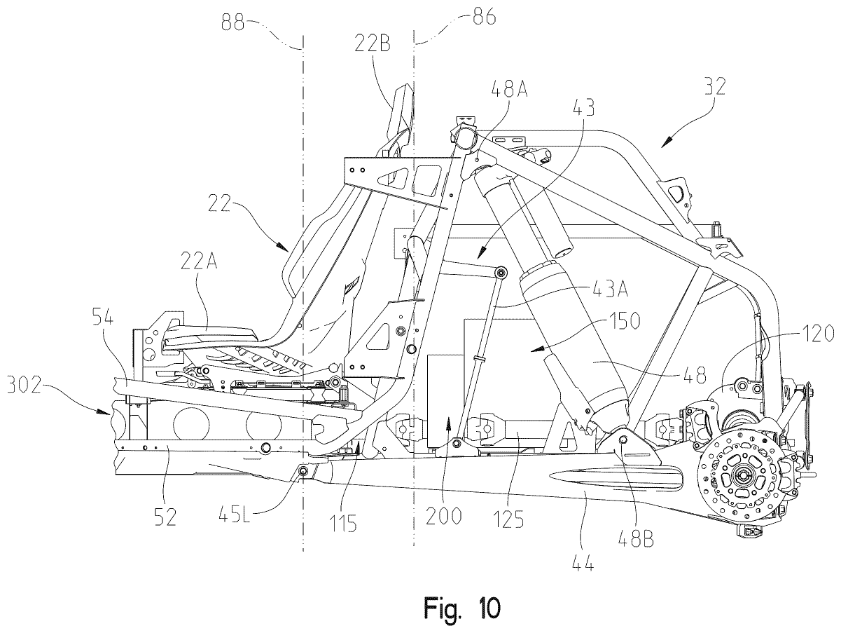

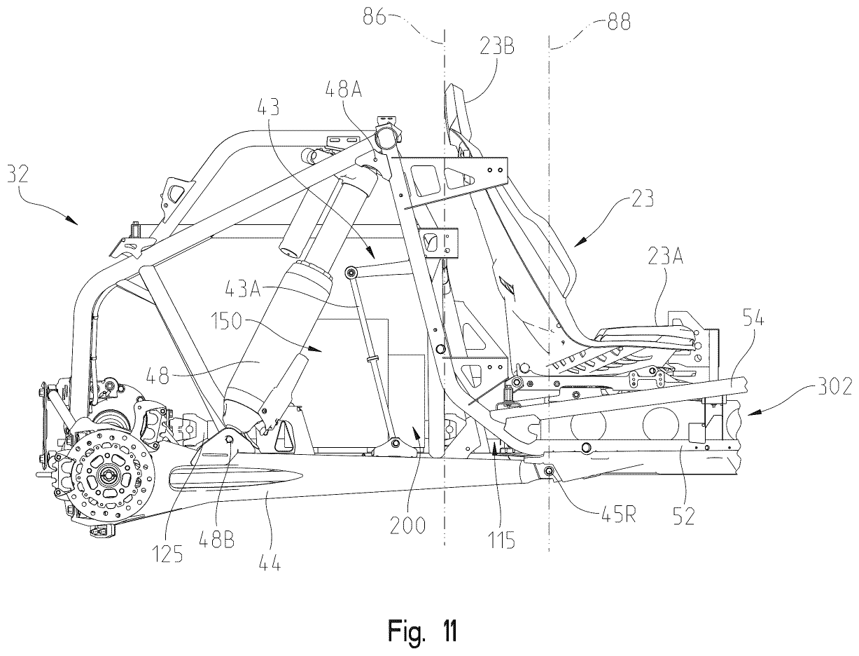

Motor 150, gear case 200, motor controller 155, rear drive 120 and rear propeller shaft assembly 125 are positioned rearward of batteries 302. Further, as best seen in FIGS. 10-11, motor 150 is positioned vertically higher than a lower extent of trailing arms 44 when vehicle 2 and trailing arms 44 are at a neutral, resting position.

Vehicle 2 also includes a sway bar 43 coupled to each of trailing arms 44L and 44R and a portion of sway bar 43 is coupled to lower frame assembly 10. Further, a portion of sway bar 43 extends forwardly of motor 150. In various embodiments, sway bar 43 extends to a position vertically higher than motor 150. In various embodiments, an entirety of sway bar 43 is positioned longitudinally rearward of batteries 302.

Referring again to FIG. 13, first propeller shaft 116 is positioned laterally between batteries 302A, 302B. Further, first propeller shaft 116 is positioned above a lower extent of batteries 302, and in various embodiments, first propeller shaft 116 is positioned below an upper extent of batteries 302. In the present embodiment, first propeller shaft 116 is a cylindrical tube with diameter 116D. In the present embodiment, first propeller shaft diameter 116D is sized so that it is approximately 50% of a width 327 between inner walls 326A, 326B. In various embodiments, propeller shaft diameter 116D is sized so that it is less than 90% of the width 327. In various embodiments, propeller shaft diameter 116D is sized so that it is less than 75% of the width 327. Propeller shaft diameter 116D is appropriately sized to provide clearance between first propeller shaft 116 and inner walls 326A, 326B.

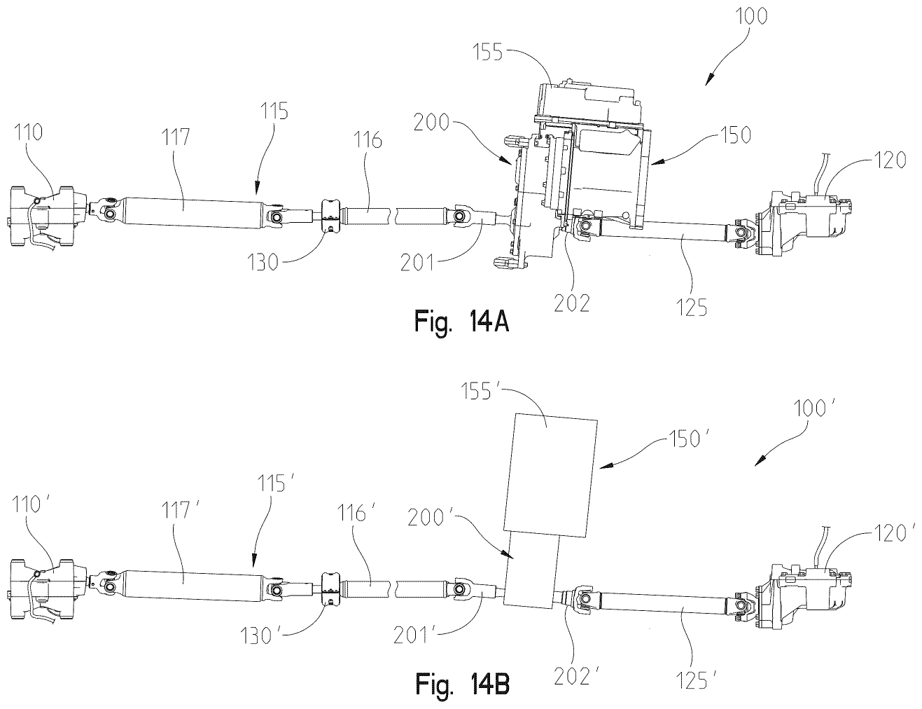

Now referring to FIGS. 14A-14B, motor controller 155 is operably coupled to motor 150, and motor 150 provides rotational power to chain case 200. Chain case 200 provides rotational power to forward output 201 and rearward output 202, and rearward output 202 transmits rotational power to rear propeller shaft assembly 125 which provides rotational power to rear drive 120. Further, forward output 201 provides rotational power to front propeller shaft assembly 115. Illustratively, front propeller shaft assembly 115 includes first propeller shaft 116 which is supported by carrier bearing 130 before transmitting rotational power to second propeller shaft 117. Finally, front propeller shaft assembly 115 transmits rotational power to front drive 110.

A second powertrain assembly 100′ is illustrated in FIG. 14B. In various embodiments, vehicle 2 may include powertrain assembly 100′. Powertrain assembly 100′ includes a motor 150′ and a motor controller 155′. Further, motor 150′ is positioned such that an output is facing generally towards the side of vehicle 2. That is, motor 150′ is positioned in a generally east/west, or lateral output, configuration, and has an output facing a direction generally perpendicular to vehicle centerline 75. Powertrain assembly 100′ also includes a transmission 200′ configured to transmit rotational power from motor 150′ to forward output 201′ and rearward output 202′. In various embodiments, transmission 200′ is a right angle drive, a differential, a transaxle, or other transmission assembly. Rearward output 202′ transmits rotational power to rear propeller shaft assembly 125′, which provides power to rear drive 120′. Forward output 201′ transmits rotational power to front propeller shaft 115′ which includes a first propeller shaft 116′ and a second propeller shaft 117′. Further, first propeller shaft may be supported by a carrier bearing 130′, and front propeller shaft 115′ provides rotational power to front drive 110′.

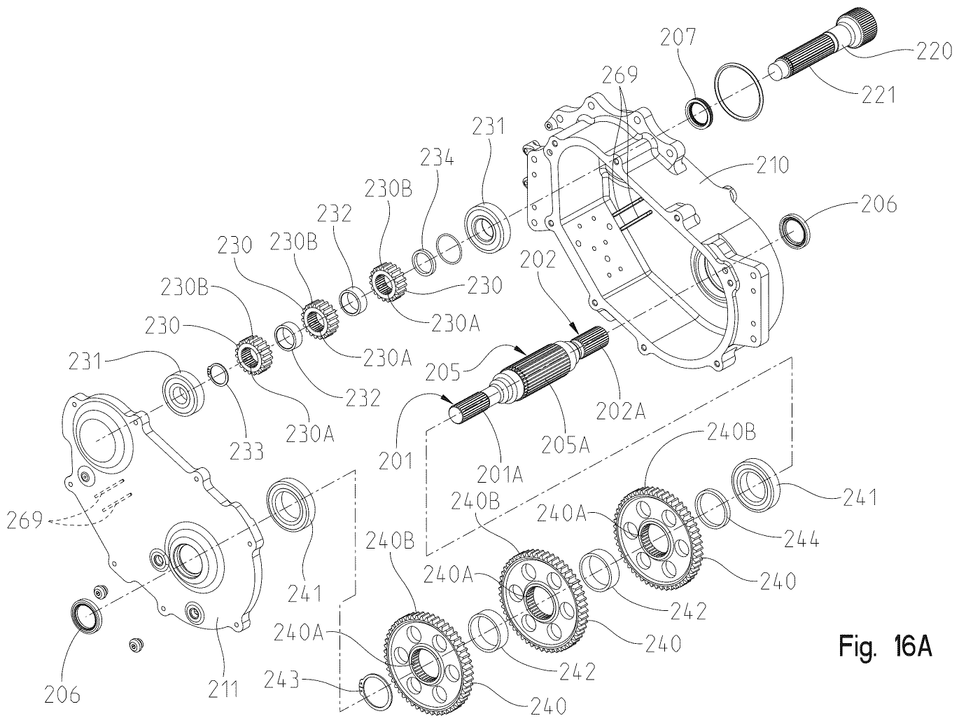

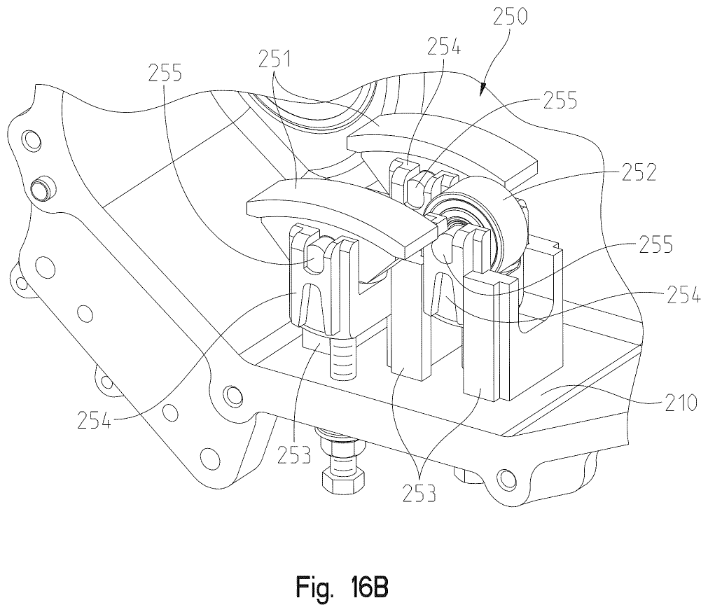

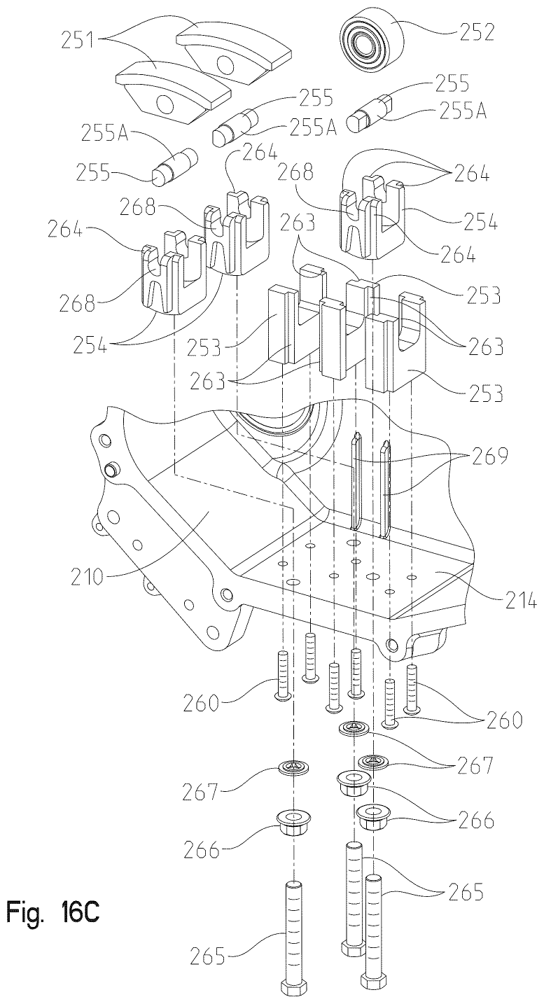

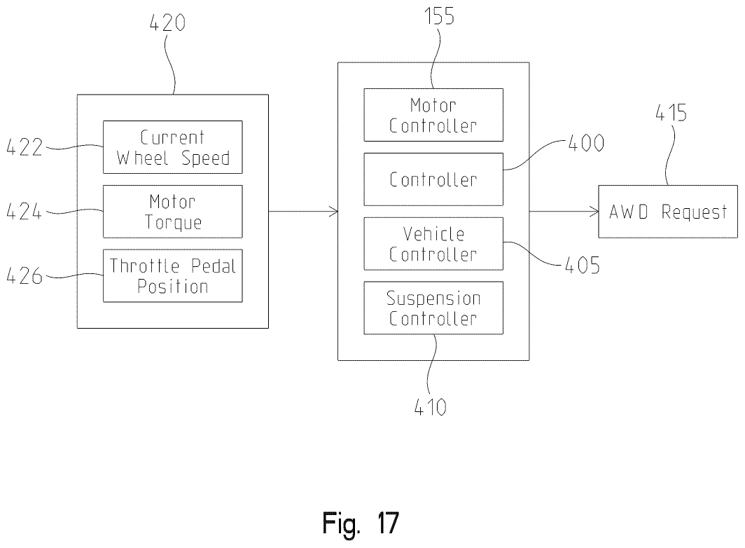

Referring now to FIGS. 15A-16C, chain case 200 will be explained in greater detail. Chain case 200 includes a chain case body 210 and a chain case cover 211. Chain case cover 211 may be coupled to chain case body 210 using fasteners, a weld, an adhesive, or other method of coupling. Illustratively, forward motor mounts 153 are integrated into chain case body 210. In various embodiments, motor mounts 153 are coupled to chain case body 210 using fasteners such as bolts. As best shown in FIG. 15C, chain case 200 includes an input 220 and forward output 201 and rearward output 202. Input 220 is generally a rod which extends through opening 220A and includes a splined surface 221 extending a length of input 220. Input 220 extends across chain case 200 and a portion of input 220 is positioned adjacent chain case cover 211. Input 220 is configured to receive rotational power from motor 150. Chain case 200 also includes a plurality of input gears 230 configured with an inner surface 230A and an outer surface 230B. Illustratively, inner surface 230A includes complementary splines to mate with splined surface 221, and gears 230 are coupled to input 220 such that gears 230 rotate with input 220. Chain case 200 also includes a plurality of spacers 232 configured to maintain a consistent spacing between gears 230. In the present embodiment, a pair of bearings 231 are positioned on either end of input 220 within the interior of chain case 200. Illustratively, each bearing 231 is placed in a recess 212 of chain case 200 and supports input 220. Chain case 200 also includes retainer ring 233 configured to retain input 220 within chain case 200. Additionally, chain case 200 includes a seal 207 positioned in an outer recess 208 of chain case body 210. Bearings 231 support input 220 as input 220 rotates in response to motor 150 providing rotational power to chain case 200.

Chain case 200 also includes output 205 with forward output 201 and rearward output 202. Forward output 201 includes a splined surface 201A and rearward output 202 includes splined surface 202A. Output 205 also includes a splined surface 205A located intermediate forward output 201 and rearward output 202. Chain case 200 includes output gears 240 with an inner surface 240A and an outer surface 240B. Inner surface 240A includes splines configured to engage the splined surface 205A so that gears 240 rotate with output 205. Additionally, chain case 200 includes spacers 242 configured to provide consistent spacing between output gears 240. Chain case 200 also includes a pair of bearings 241 positioned within a pair of recesses 213 in chain case 200. Bearings 241 are configured to support output 205 as it rotates. Further, chain case 200 includes a pair of seals 206 each positioned in an outside recess 209 of chain case body 210 and chain case cover 211.

Chain case also includes a chain 245 positioned around input gears 230 and output gears 240. In various embodiments, a plurality of chains 245 are positioned around input gears 230 and output gears 240 and configured to transmit rotational power between input gears 230 and output gears 240. In various embodiments, chain 245 may be a rubber belt or other endless chain/belt configured to transmit power between input gears 230 and output gears 240.

Chain case 200 also includes a chain tensioner assembly 250. Chain tensioner assembly 250 includes a plurality of support members 253. Support members 253 are positioned on an interior of chain case body 210 on first body surface 214 and coupled to chain case body 210 using fasteners 260. Support members 253 include a plurality of receiving surfaces 263. Illustratively, receiving surfaces 263 extend perpendicular to first body surface 214. Chain tensioner assembly 250 includes a plurality of movable members 254 which include a plurality of sliding surfaces 264. Sliding surfaces 264 are configured to mate and slide along receiving surfaces 263. That is, movable members 254 slide relative to support members 253. In the present embodiment, chain tensioner assembly 250 includes three support members 253 and three movable members 254. Each movable member 254 includes a slot 268 configured to receive a support 255. Chain tensioner assembly 250 includes a pair of chain sliders 251 and a wheel 252. Each chain slider 251 receives support 255 and wheel 252 receives support 255. Support 255 is configured with a cylindrical middle portion 255A configured to allow chain sliders 251 and wheels 252 to rotate about support 255. Chain sliders 251 move with movable members 254 and are positionable to contact and maintain an appropriate amount of tension on chain 245. Additionally, wheel 252 moves with movable members 254 and contacts chain 245. Chain 245 may then move along sliders 251 and wheel 252. In various embodiments, chain case 200 may include a plurality of tabs 269 positioned on chain case body 210 and a plurality of tabs 269 positioned on chain case cover 211. Tabs 269 receive sliding surfaces 264, and more particularly, movable members 254 that receive chain sliders 251 are configured to be received by tabs 269. In this way, both sliding surfaces 264 that receive chain sliders 251 are received on their outer ends. In various embodiments, tabs 269 are integrated into chain case body 210 and chain case cover 211. In various embodiments, tabs 269 are coupled using a weld, an adhesive, or other method of coupling.

In the present embodiment, movable members 254 are coupled to fasteners 265. Illustratively, fasteners 265 extend through, and are movable relative to chain case body 210. A plurality of receiving members 266 and a plurality of locking members 267 are positioned adjacent chain case body 210 and allow fasteners 265 to maintain a specific position relative to chain case body 210. A user may then position chain sliders 251 and wheel 252 so that an appropriate amount of tension is placed on chain 245 by moving the fasteners 265 relative to chain case body 210. In various embodiments, receiving members 266 and locking members 267 are coupled to chain case body 210 using a weld, an adhesive, or other method.

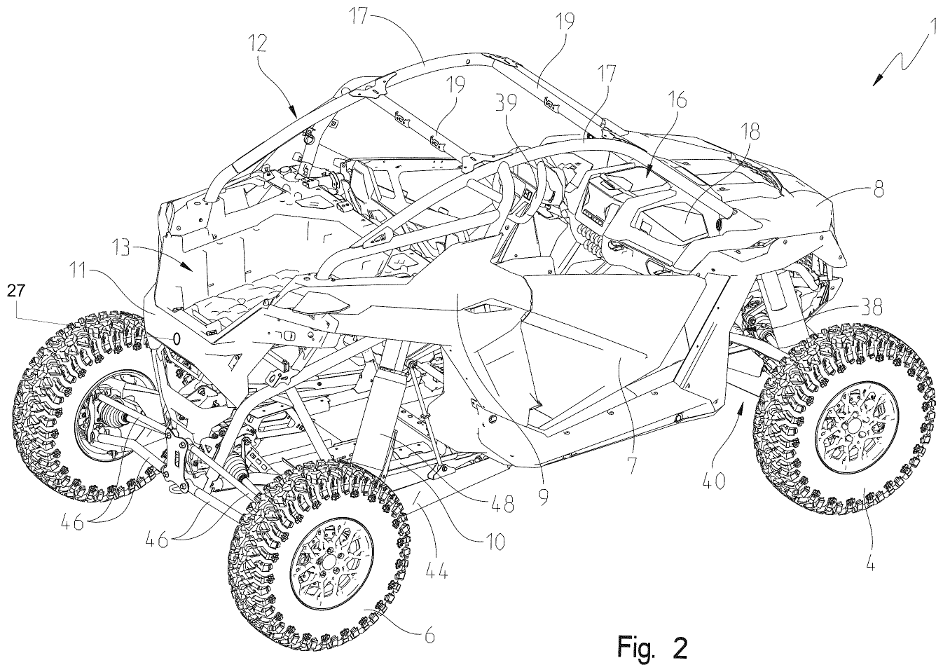

Batteries 302, motor 150, and motor controller 155 are all coupled using electrical wires (not shown). In various embodiments, electrical wires are high voltage lines, low voltage lines, or a combination of both. Vehicle 1, 2 may further include a charging system (not shown) configured to support the charging of batteries 302. Charging system is coupled to batteries 302. In various embodiments, charging system is positioned adjacent a rear of vehicle 1, 2. Charging system includes a charging port 27 (FIG. 2) positioned in rear fascia 11. In various embodiments, charging port 27 may include a cover (not shown) configured to cover the charging port 27. Charging port 27 and cover may be positioned within a recessed portion of rear fascia 11. In various embodiments, charging system is positioned in a rear half of vehicle 1, 2. In various embodiments, charging system is positioned within rear subframe area 49. In various embodiments, charging port 27 may be positioned at a vertical height greater than that of the trailing arms 44 or the control arms 46. In one embodiment, because vehicle 1, 2 includes an electric powertrain, no exhaust is needed and, as such, the charging port 27 could be positioned at a location where a muffler on a typical vehicle with an internal combustion engine is located. In various embodiments, charging port 27 is positioned along a vehicle centerline 75. In various embodiments, charging port 27 may be positioned on a front half of vehicle 1, 2. In various embodiments, charging port 27 may be located on hood 8, or adjacent a grill (not shown) of vehicle 1, 2.

Referring to FIG. 17, vehicle 2 may also include at least one of a plurality of controllers, including motor controller 155, a controller 400, a vehicle controller 405, and a suspension controller 410. Vehicle 1, 2 may also include a plurality of sensors (not shown) configured to provide a plurality of inputs 420, including current wheel speed 422, motor torque 424, and throttle pedal position 426. In the present embodiment, vehicle 2 may be configured to monitor inputs 420 and deny or allow an All-Wheel Drive (AWD) request 415 in response to the inputs 420. In various examples, either of controllers 155, 400, 405 may determine when front drive 110 can be engaged to allow All-Wheel Drive. If a current motor torque 424 is above a threshold, front drive 110 may not be engaged, and front drive 110 may only be engaged if a current motor torque 424 falls below a specific threshold. Additionally, both a wheel speed differential and a current motor torque may be used to determine if a front drive 110 is allowed to be engaged or disengaged.

Additional details of vehicle 1, 2 may be found in U.S. patent application Ser. No. 17/282,652, filed Oct. 3, 2019, titled HYBRID UTILITY VEHICLE, attorney docket no. PLR-09-28386.02P-US; U.S. Pat. No. 8,496,079, issued Jul. 30, 2013, titled ELECTRIC VEHICLE AND ON-BOARD BATTERY CHARGING APPARATUS THEREFOR, attorney docket no. PLR-00SA-24396.01P-US; U.S. Pat. No. 10,118,477, issued Nov. 6, 2018, titled HYBRID UTILITY VEHICLE, attorney docket no. PLR-09-27423.02P-US; U.S. patent application Ser. No. 17/214,241, filed Mar. 26, 2021, titled UTILITY VEHICLE, attorney docket no. PLR-09-29163.02P-US; U.S. Pat. No. 10,603,997, issued Mar. 31, 2020, titled ELECTRIC VEHICLE, attorney docket no. PLR-05-25329.03P-US, the complete disclosures of which are expressly incorporated by reference herein.

The following examples are provided.

Example 1. A vehicle, comprising: a plurality of ground engaging members; a frame supported by the plurality of ground engaging members; a vehicle centerline extending longitudinally at a lateral midpoint of the vehicle; a plurality of seats supported by the frame; and a powertrain comprising: a battery supported by the frame, the battery positioned at least partially under at least one of the plurality of seats; an electric motor positioned rearward of the battery, the electric motor supported by the frame; a propeller shaft extending from a position rearward of the battery to a position forward of the battery, the first propeller shaft extending along a portion of the vehicle centerline; and when viewed from a side perspective view, the propeller shaft laterally overlaps at least a portion of the battery.

Example 2. The vehicle of Example 1, wherein the motor comprises a motor output, and the motor output is angled relative to the vehicle centerline.

Example 3. The vehicle of Example 1, wherein the propeller shaft comprises a first propeller shaft and a second propeller shaft.

Example 4. The vehicle of Example 3, further comprising a carrier bearing supporting the first propeller shaft, and the carrier bearing positioned forward of the battery.

Example 5. The vehicle of Example 3, wherein the first propeller shaft has a diameter less than that of the second propeller shaft.

Example 6. The vehicle of Example 1, further comprising a carrier bearing supporting the propeller shaft; and the carrier bearing is positioned forward of the battery.

Example 7. The vehicle of Example 1, wherein the electric motor intersects the vehicle centerline.

Example 8. A vehicle, comprising: a plurality of ground engaging members; a frame supported by the plurality of ground engaging members, a plurality of seats supported by the frame; a first trailing arm extending generally longitudinally, the first trailing arm coupling a first wheel of the plurality of ground engaging members to the frame at a first mounting point; a second trailing arm extending generally longitudinally, the second trailing arm coupling a second wheel of the plurality of ground engaging members to the frame at a second mounting point; and a powertrain comprising: an electric motor positioned rearward of the first mounting point and the second mounting point; a battery positioned forward of the first mounting point and the second mounting point; and the electric motor and the battery are positioned vertically lower than at least a portion of at least one of the plurality of seats.

Example 9. The vehicle of Example 8, wherein a lateral extent of the battery is laterally outward of a lateral extent of the motor.

Example 10. The vehicle of Example 8, further comprising: a transmission coupled to the electric motor, the transmission positioned forward of the electric motor and vertically lower than at least one of the plurality of seats.

Example 11. The vehicle of Example 10, wherein the transmission is positioned longitudinally rearward of the first mounting point and the second mounting point.

Example 12. The vehicle of Example 11, further comprising: a propeller shaft extending forward from the transmission, the propeller shaft extending adjacent the battery.

Example 13. A vehicle, comprising: a plurality of ground engaging members; a frame supported by the plurality of ground engaging members; a first trailing arm coupled between the frame and a first ground engaging member of the plurality of ground engaging members, the first trailing arm coupled to the frame at a first mounting point and coupled to the first ground engaging member at a second mounting point; a second trailing arm coupled between the frame and a second ground engaging member of the plurality of ground engaging members, the second trailing arm coupled to the frame at a third mounting point and coupled to the second ground engaging member at a fourth mounting point; a first shock absorber extending between the frame at a first shock mounting point and the first trailing arm at a second shock mounting point; a second shock absorber extending between the frame at a third shock mounting point and the second trailing arm at a fourth shock mounting point; a boundary defined by a plurality of lines drawn through the first mounting point, the second mounting point, the third mounting point, and the fourth mounting point; a powertrain comprising: an electric motor supported by the frame; a transmission supported by the frame, the transmission and electric motor operably coupled; and the electric motor and the transmission positioned completely within the boundary.

Example 14. The vehicle of Example 13, further comprising: a sway bar, the sway bar coupled to the first trailing arm, the second trailing arm, and the frame; and the sway bar extending within the boundary.

Example 15. The vehicle of Example 13, further comprising: a battery supported by the frame, the battery electrically coupled to the electric motor; and when the vehicle is viewed from a front view, the battery is positioned horizontally intermediate the second mounting point and the fourth mounting point.

Example 16. The vehicle of Example 13, wherein the motor is positioned laterally intermediate, and vertically below, the first shock mounting point and the third shock mounting point.

Example 17. The vehicle of Example 13, further comprising a motor controller; and the motor controller is positioned within the boundary.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a plurality of ground engaging members;
a frame supported by the plurality of ground engaging members;
a vehicle centerline extending longitudinally at a lateral midpoint of the vehicle;
a plurality of seats supported by the frame; and
a powertrain comprising:
a battery supported by the frame, the battery positioned at least partially under at least one of the plurality of seats;
an electric motor positioned rearward of the battery, the electric motor supported by the frame;
a propeller shaft extending from a position rearward of the battery to a position forward of the battery, the first propeller shaft extending along a portion of the vehicle centerline; and
when viewed from a side perspective view, the propeller shaft laterally overlaps at least a portion of the battery.

2. The vehicle of claim 1, wherein the motor comprises a motor output, and the motor output is angled relative to the vehicle centerline.

3. The vehicle of claim 1, wherein the propeller shaft comprises a first propeller shaft and a second propeller shaft.

4. The vehicle of claim 3, further comprising a carrier bearing supporting the first propeller shaft, and the carrier bearing positioned forward of the battery.

5. The vehicle of claim 3, wherein the first propeller shaft has a diameter less than that of the second propeller shaft.

6. The vehicle of claim 1, further comprising a carrier bearing supporting the propeller shaft; and
the carrier bearing is positioned forward of the battery.

7. The vehicle of claim 1, wherein the electric motor intersects the vehicle centerline.

8. A vehicle, comprising:
a plurality of ground engaging members;
a frame supported by the plurality of ground engaging members, a plurality of seats supported by the frame;
a first trailing arm extending generally longitudinally, the first trailing arm coupling a first wheel of the plurality of ground engaging members to the frame at a first mounting point;
a second trailing arm extending generally longitudinally, the second trailing arm coupling a second wheel of the plurality of ground engaging members to the frame at a second mounting point; and
a powertrain comprising:
an electric motor positioned rearward of the first mounting point and the second mounting point;
a battery positioned forward of the first mounting point and the second mounting point; and
the electric motor and the battery are positioned vertically lower than at least a portion of at least one of the plurality of seats.

9. The vehicle of claim 8, wherein a lateral extent of the battery is laterally outward of a lateral extent of the motor.

10. The vehicle of claim 8, further comprising:
a transmission coupled to the electric motor, the transmission positioned forward of the electric motor and vertically lower than at least one of the plurality of seats.

11. The vehicle of claim 10, wherein the transmission is positioned longitudinally rearward of the first mounting point and the second mounting point.

12. The vehicle of claim 11, further comprising:
a propeller shaft extending forward from the transmission, the propeller shaft extending adjacent the battery.

13. A vehicle, comprising:
a plurality of ground engaging members;
a frame supported by the plurality of ground engaging members;
a first trailing arm coupled between the frame and a first ground engaging member of the plurality of ground engaging members, the first trailing arm coupled to the frame at a first mounting point and coupled to the first ground engaging member at a second mounting point;
a second trailing arm coupled between the frame and a second ground engaging member of the plurality of ground engaging members, the second trailing arm coupled to the frame at a third mounting point and coupled to the second ground engaging member at a fourth mounting point;
a first shock absorber extending between the frame at a first shock mounting point and the first trailing arm at a second shock mounting point;
a second shock absorber extending between the frame at a third shock mounting point and the second trailing arm at a fourth shock mounting point;
a boundary defined by a plurality of lines drawn through the first mounting point, the second mounting point, the third mounting point, and the fourth mounting point; and
a powertrain comprising:
an electric motor supported by the frame;
a transmission supported by the frame, the transmission and electric motor operably coupled; and
the electric motor and the transmission positioned completely within the boundary.

14. The vehicle of claim 13, further comprising:
a sway bar, the sway bar coupled to the first trailing arm, the second trailing arm, and the frame; and
the sway bar extending within the boundary.

15. The vehicle of claim 13, further comprising:
a battery supported by the frame, the battery electrically coupled to the electric motor; and
when the vehicle is viewed from a front view, the battery is positioned horizontally intermediate the second mounting point and the fourth mounting point.

16. The vehicle of claim 13, wherein the motor is positioned laterally intermediate, and vertically below, the first shock mounting point and the third shock mounting point.

17. The vehicle of claim 13, further comprising a motor controller; and
the motor controller is positioned within the boundary.
